(19) United States
(12) Patent Application Publication
(10) Pub. No.: US 2012/0159519 A1
(43) Pub. Date: Jun. 21, 2012

(54) EVENT DEPENDENCY MANAGEMENT APPARATUS AND EVENT DEPENDENCY MANAGEMENT METHOD

(75) Inventor: Yuichi Matsuda, Kawasaki (JP)

(73) Assignee: FUJITSU LIMITED, Kawasaki-shi (JP)

(21) Appl. No.: 13/288,136

(22) Filed: Nov. 3, 2011

(30) Foreign Application Priority Data
Dec. 17, 2010 (JP) 2010-282212

(51) Int. Cl. G06F 9/46

(52) U.S. Cl. 719/318

(57) ABSTRACT

An event dependency management apparatus manages a first managed object at which a first event may occur, a second managed object at which a second event may occur in dependence upon the first event, and a third managed object at which a third event may occur in dependence upon the second event. The event dependency management apparatus includes a processor to calculate a difference between an occurrence time of the first event and an occurrence time of the third event, and determine that the third event has occurred in dependence upon the first event when the calculated difference is smaller than a predetermined time.

### CROSS-REFERENCE TO RELATED APPLICATION

This application is based upon and claims the benefit of priority of the prior Japanese Patent Application No. 2010-282212, filed on Dec. 17, 2010, the entire contents of which are incorporated herein by reference.

### FIELD

The embodiments discussed herein are related to an event dependency management apparatus and an event dependency management method.

### BACKGROUND

A technology is known in which event information regarding a plurality of monitored functions in a predetermined time period is collected and grouped, an occurrence pattern of event information in the event group is compared to occurrence patterns defined in pattern definitions, a pattern definition group including an occurrence pattern similar to the occurrence pattern of event information in the event group is selected, and information regarding a countermeasure against a failure, that has been associated in advance with the selected pattern definition group, is extracted. In addition, a technology is known in which event information regarding the first event and selected messages after the first event are stored as event log information, but duplicated messages are not stored.

International Publication No. 2004/061681 and Japanese Laid-open Patent Publication (Translation of PCT Application) No. 2004-535018 disclose related techniques.

### SUMMARY

According to an aspect of the present invention, provided is an event dependency management apparatus for managing a first managed object at which a first event may occur, a second managed object at which a second event may occur in dependence upon the first event, and a third managed object at which a third event may occur in dependence upon the second event. The event dependency management apparatus includes a processor to calculate a difference between an occurrence time of the first event and an occurrence time of the third event, and determine that the third event has occurred in dependence upon the first event when the calculated difference is smaller than a predetermined time.

The object and advantages of the invention will be realized and attained by means of the elements and combinations particularly pointed out in the claims. It is to be understood that both the foregoing general discussion and the following detailed discussion are exemplary and explanatory and are not restrictive of the invention, as claimed.

### BRIEF DESCRIPTION OF DRAWINGS

FIG. 1 is a diagram illustrating an exemplary functional configuration of an event information management system according to an embodiment of the present invention;

FIG. 2 is a diagram illustrating an exemplary data structure of event information generated in a managed object according to an embodiment of the present invention;

FIG. 3 is a diagram illustrating an exemplary hardware configuration of a computer;

FIG. 4 is a diagram illustrating an exemplary functional configuration of an event information management apparatus according to an embodiment of the present invention;

FIG. 5 is a diagram illustrating an exemplary process allocation table according to an embodiment of the present invention;

FIG. 6 is a diagram illustrating exemplary dependency information according to an embodiment of the present invention;

FIG. 7 is a diagram illustrating exemplary dependency information according to an embodiment of the present invention;

FIGS. 8A to 8F are diagrams illustrating exemplary dependency information according to an embodiment of the present invention;

FIGS. 9A to 9F are diagrams illustrating exemplary dependency information according to an embodiment of the present invention;

FIG. 10 is a diagram illustrating a concrete example of an event dependency determination process performed by an event dependency determination unit according to an embodiment of the present invention;

FIG. 11 is a diagram illustrating a concrete example of an event dependency determination process performed by an event dependency determination unit according to an embodiment of the present invention;

FIG. 12 is a diagram illustrating an exemplary integrated management DB according to an embodiment of the present invention;

FIG. 13 is a diagram illustrating an exemplary event dependency management apparatus according to an embodiment of the present invention;

FIG. 14 is a diagram illustrating a concrete example of an undetected event occurred at a midway point;

FIG. 15 is a diagram illustrating a concrete example of estimation of an event dependency relating to an undetected event occurred at a midway point according to an embodiment of the present invention;

FIG. 16 is a diagram illustrating a concrete example of an undetected event occurred at a starting point;

FIG. 17 is a diagram illustrating a concrete example of estimation of an event dependency relating to an undetected event occurred at a starting point according to an embodiment of the present invention;

FIG. 18 is a diagram illustrating an exemplary operation flow of an event information management procedure performed by an event information management apparatus according to an embodiment of the present invention;

FIG. 19 is a diagram illustrating an exemplary detailed operation flow of an event dependency determination process according to an embodiment of the present invention;

FIG. 20 is a diagram illustrating an exemplary detailed operation flow of a starting-point determination process according to an embodiment of the present invention;

FIG. 21 is a diagram illustrating an exemplary detailed operation flow of an undetected midway-point event determination process according to an embodiment of the present invention;

FIG. 22 is a diagram illustrating an exemplary detailed operation flow of an undetected starting-point event determination process according to an embodiment of the present invention;

FIG. 23 is a diagram illustrating a concrete example of estimation of an event dependency relating to an undetected event occurred at a starting point according to an embodiment of the present invention; and

FIG. 24 is a diagram illustrating an exemplary detailed operation flow of an undetected starting-point event determination process according to an embodiment of the present invention.

### DESCRIPTION OF EMBODIMENTS

When there are dependencies among the monitored objects, an event occurred at a depended monitored object may cause an event at a dependent monitored object. If it is detected that two events have occurred within a predetermined time period at two different monitored objects which have a dependency, respectively, it may be determined that the two detected events have a relationship. However, in conventional techniques, if one of the two events is not detected, the dependency may not be recognized.

It is preferable to provide a technique to recognize a dependency between events even if one of the events fails to be detected.

According to the embodiments, a dependency between events may be recognized even if one of the events fails to be detected.

An event dependency management apparatus and an event dependency management method according to embodiments of the present invention will be discussed in detail with reference to the accompanying drawings.

Example of Event Information Management System

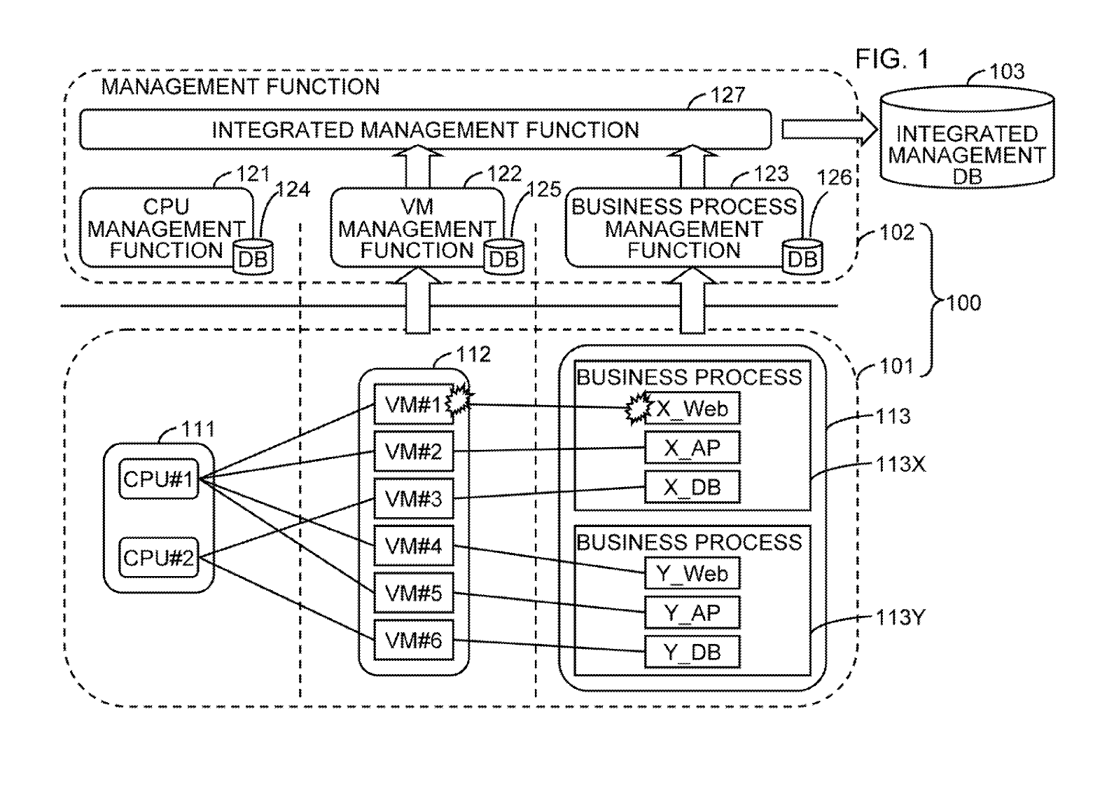

FIG. 1 illustrates an exemplary functional configuration of an event information management system 100 according to the embodiments. The event information management system 100 includes a managed apparatus 101, a management function 102 that manages the managed apparatus 101, and an integrated management database (DB) 103. The event information management system 100 may be one computer or may include a plurality of computers.

Firstly, the managed apparatus 101 will be discussed below. The managed apparatus 101 is an aggregation of plural types of managed objects. For example, when applied to cloud computing, three types of objects, that is, a central processing unit (CPU), a virtual machine (VM), and a business process, may be the managed objects.

In FIG. 1, the managed object are a CPU group 111 including a CPU#1 and a CPU#2, a VM group 112 including a VM#1 to a VM#6, and a business process group 113 including a business process 113X for business X and a business process 113Y for business Y. The business process 113X includes a X_Web, a X_AP, and a X_DB. The business process 113Y includes a Y_Web, a Y_AP, and a Y_DB. The X_Web and the Y_Web are processes each of which is described in a program and functions as a Web server. The X_AP and the Y_AP are processes each of which is described in a program and functions as an application server. The X_DB and the Y_DB are processes each of which is described in a program and functions as a database server.

In the example illustrated in FIG. 1, the CPU#1 controls the VM#1, VM#2, VM#4, and VM#5, and the CPU#2 controls the VM#3 and VM#6. The VM#1 controls the X_Web. The VM#2 controls the X_AP. The VM#3 controls the X_DB. The VM#4 controls the Y_Web. The VM#5 controls the Y_AP. The VM#6 controls the Y_DB.

In the managed apparatus 101, the CPU group 111 controls the VM group 112, and the VM group 112 controls the business process group 113. Therefore, if a failure occurs at a managed object that functions as a controller of other managed objects, the failure may cause other failures to occur at the other managed objects. For example, if a failure occurs at the CPU#1, failures may occur at the VM#1, VM#2, VM#4, and VM#5. In a similar way, if a failure occurs at the VM#1, a failure may also occur at the X_Web owing to the failure at the VM#1.

As discussed above, in regard to an occurrence of a failure, a managed object that is a controlled object controlled by a controller depends on a managed object that functions as the controller controlling the controlled object. Hereinafter, the managed object that functions as the controller will be referred to as a “depended managed object”. The managed object that is the controlled object will be referred to as a “dependent managed object”. In FIG. 1, the CPU group 111 is a depended managed object in relation to the VM group 112, and the VM group 112 is a dependent managed object in relation to the CPU group 111. In a similar way, the VM group 112 is a depended managed object in relation to the business process group 113, and the business process group 113 is a dependent managed object in relation to the VM group 112. Hereinafter, the above-discussed relationship between a depended managed object and a dependent managed object will be referred to as a dependency.

As is clear from the above discussion, the CPU group 111 may be a depended managed object, but may not be a dependent managed object, while the business process group 113 may be a dependent managed object, but may not be a depended managed object. The VM group 112 may be a depended managed object as well as a dependent managed object.

Next, the management function 102 will be discussed below. The management function 102 includes a management function for each type of managed objects. For example, the management function 102 includes a CPU management function 121 corresponding to the CPU group 111, a VM management function 122 corresponding to the VM group 112, and a business process management function 123 corresponding to the business process group 113.

The CPU management function 121 is described in software and manages the CPU group 111 in the managed apparatus 101. The VM management function 122 is described in software and manages the VM group 112 in the managed apparatus 101. The business process management function 123 is described in software and manages the business process group 113 in the managed apparatus 101. The above management functions 121 to 123 have DBs 124 to 126, respectively, and collect event information reported from corresponding managed objects when a failure or an accident occurs at each managed object or when the monitoring status of a communication condition changes, to store the event information as a log.

The management function 102 also includes an integrated management function 127. The integrated management function 127 aggregates event information which has been separately stored in accordance with the types of managed objects and stores the aggregated event information in the integrated management DB 103 as logs. According to the embodiments, the integrated management function 127 screens event information to be stored in the integrated management DB 103 in order to reduce event information stored redundantly with the DBs 124 to 126 managed by the management functions 121 to 123, respectively.

Specifically, from the viewpoint of an administrator or the integrated management function 127, for example, event information regarding a failure reported from a starting point of failures is more important than other event information. Therefore, the integrated management function 127 selects event information required for identifying failed managed objects among from event information regarding failures stored in the DBs 124 to 126 and stores the selected event information in the integrated management DB 103 as logs. It is not necessary to store other event information in the integrated management DB 103 because they are stored in the DBs 124 to 126. They may be read out as required from the DBs 124 to 126 by using the event information stored in the integrated management DB 103 as clues.

Exemplary Data Structure of Event Information

A data structure of event information generated in the above discussed managed objects will be discussed.

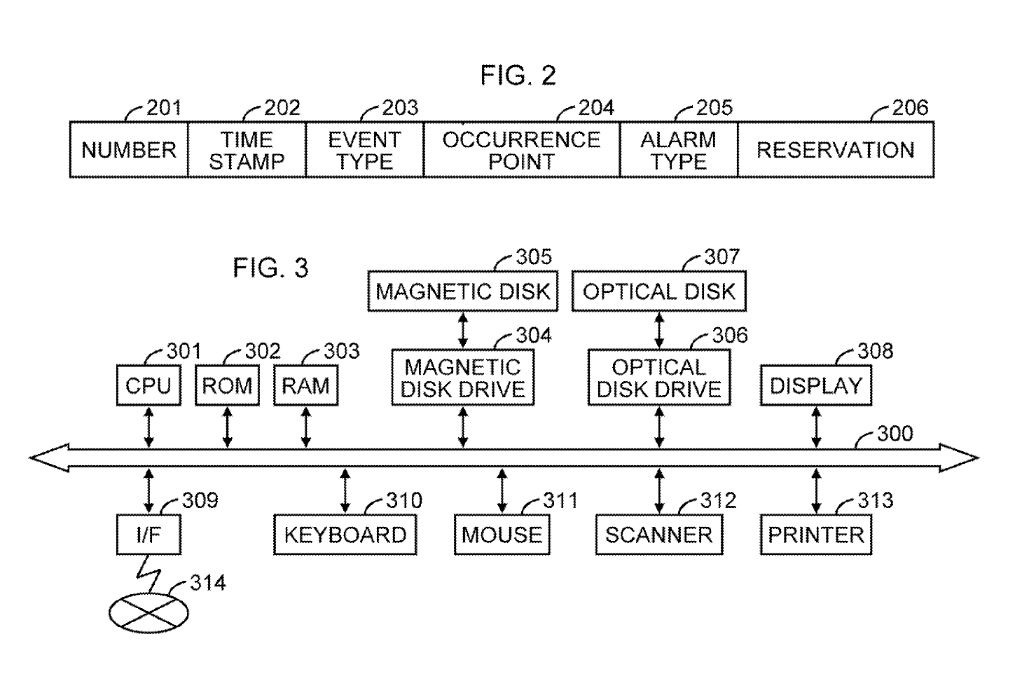

FIG. 2 illustrates an exemplary data structure of event information generated in a managed object according to the embodiments. Event information includes items such as a “number” item 201, a “time stamp” item 202, an “event type” item 203, an “occurrence point” item 204, an “alarm type” item 205, and a “reservation” item 206. The “number” item 201 stores a serial number attached to an event frame. The “time stamp” item 202 stores an occurrence time (2009_{—}09_{—}05_{—}17:58:23, for example) of an event.

The “event type” item 203 stores a flag (“0” for an alarm event, and “1” for a quality monitoring event, for example) for identifying event types. The “occurrence point” item 204 stores identification information (CPU#1, VM#2, or X_Web, for example) for identifying a managed object at which an event has occurred. The “alarm type” item 205 stores identification information for identifying a type (regarding an apparatus, regarding the VM group 112, regarding an application, regarding a communication, or regarding qualities, for example) of alarms. The “reservation” item 206 stores information defined as required.

Hardware Configuration of Computer

FIG. 3 illustrates an exemplary hardware configuration of a computer used in the embodiments. As illustrated in FIG. 3, the computer includes a CPU 301, a read-only memory (ROM) 302, a random access memory (RAM) 303, a magnetic disk drive 304, a magnetic disk 305, an optical disk drive 306, an optical disk 307, a display 308, an interface (I/F) 309, a keyboard 310, a mouse 311, a scanner 312, and a printer 313. The above constituent devices are connected to each other via a bus 300.

The CPU 301 is in charge of controlling the entirety of the computer. The ROM 302 stores a boot program and the like. The RAM 303 is used as a work area by the CPU 301. The magnetic disk drive 304 controls operations of reading data from or writing data to the magnetic disk 305 under the control of the CPU 301. The magnetic disk 305 stores data written under the control of the magnetic disk drive 304.

The optical disk drive 306 controls operations of reading data from or writing data to the optical disk 307 under the control of the CPU 301. The optical disk 307 stores data written under the control of the optical disk drive 306.

The display 308 displays data such as documents, images, and function information as well as a cursor, icons or tool boxes. The display 308 may be a cathode-ray tube (CRT), a thin-film transistor (TFT) liquid crystal display, or a plasma display.

The I/F 309 is connected to a network 314 such as a local area network (LAN), a wide area network (WAN), or the Internet via a communication line. The I/F 309 is connected to other apparatuses over the network 314. The I/F 309 is in charge of an interface between the network 314 and the inside of the computer, and controls inputs from and outputs to external apparatuses. The I/F 309 may be a modem, a LAN adapter, or the like.

The keyboard 310 is equipped with keys for inputting characters, numbers, various instructions, and the like, and data is input to the computer using the keyboard 310. A touch panel type input pad or a numeric keypad may be used instead of the keyboard 310. The mouse 311 is used for moving a cursor, selecting an area, moving a window, or changing a size of a window. Any pointing devices (a track ball or a joystick, for example) having a function similar to that of the mouse 311 may be used instead of the mouse 311.

The scanner 312 optically reads out images, and inputs image data to the computer. The scanner 312 may have a function of an optical character reader (OCR). The printer 313 prints image data and document data. The printer 313 may be a laser printer or an ink-jet printer.

Functional Configuration of Event Information Management Apparatus

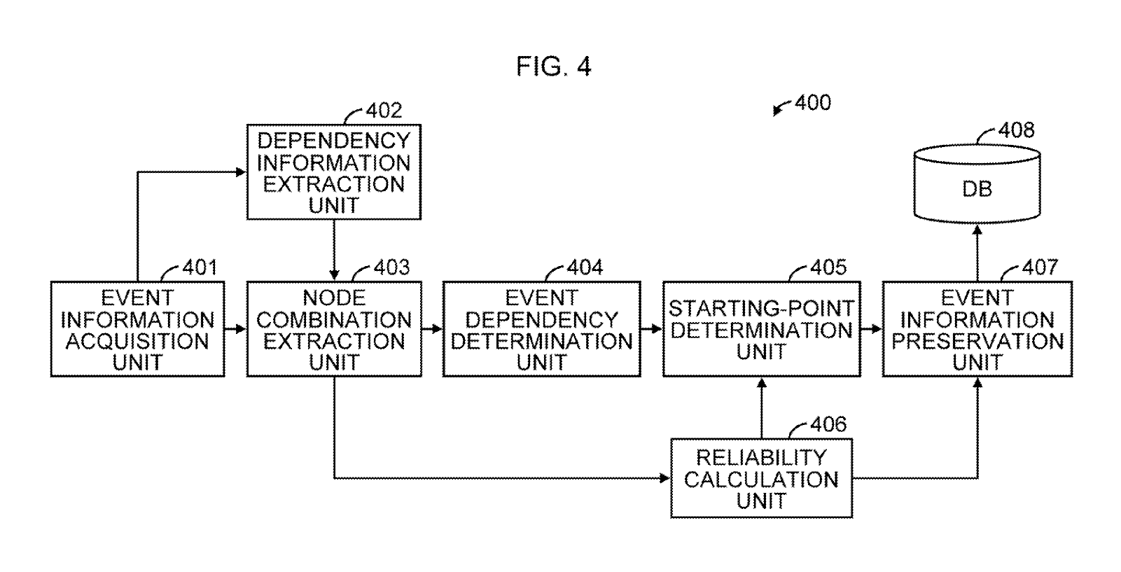

A functional configuration of an event information management apparatus will be discussed. FIG. 4 illustrates an exemplary functional configuration of an event information management apparatus 400 according to the embodiments. The event information management apparatus 400 illustrated in FIG. 4 corresponds to the integrated management function 127 illustrated in FIG. 1. The event information management apparatus 400 includes an event information acquisition unit 401, a dependency information extraction unit 402, a node combination extraction unit 403, an event dependency determination unit 404, a starting-point determination unit 405, a reliability calculation unit 406, an event information preservation unit 407, and a DB 408. Specifically, the functions of the event information acquisition unit 401 to the event information preservation unit 407 may be realized, for example, by causing the CPU 301 to execute programs stored in storage devices such as the ROM 302, the RAM 303, the magnetic disk 305, and the optical disk 307 illustrated in FIG. 3, or by using the I/F 309.

The event information acquisition unit 401 has a function of acquiring a plural pieces of event information regarding events that have occurred in a predetermined time period, from the databases for respective types of managed objects, which store event information corresponding to respective types of managed objects. Specifically, the event information acquisition unit 401 reads out plural pieces of event information regarding events that have occurred in a predetermined time period, with reference to the time stamps of the event information stored in the DBs 124 to 126.

The dependency information extraction unit 402 has a function of extracting managed objects that have dependencies with each other on the basis of information regarding an occurrence point stored in each piece among the plural pieces of event information acquired by the event information acquisition unit 401. Specifically, identification information of a managed object is written in the “occurrence point” item 204 of each piece of event information acquired by the event information acquisition unit 401. Managed objects that have dependencies with each other may be extracted by using this identification information as a clue.

For example, if “CPU#2”, “VM#3”, “VM#6”, “X_DB”, and “Y_DB” are stored in the “occurrence point” item 204 of respective pieces of acquired event information, “CPU#2”, “VM#3”, “VM#6”, “X_DB”, and “Y_DB” are extracted as managed objects that have dependencies with each other. In the above-discussed extraction by the dependency information extraction unit 402, a process allocation table may be used.

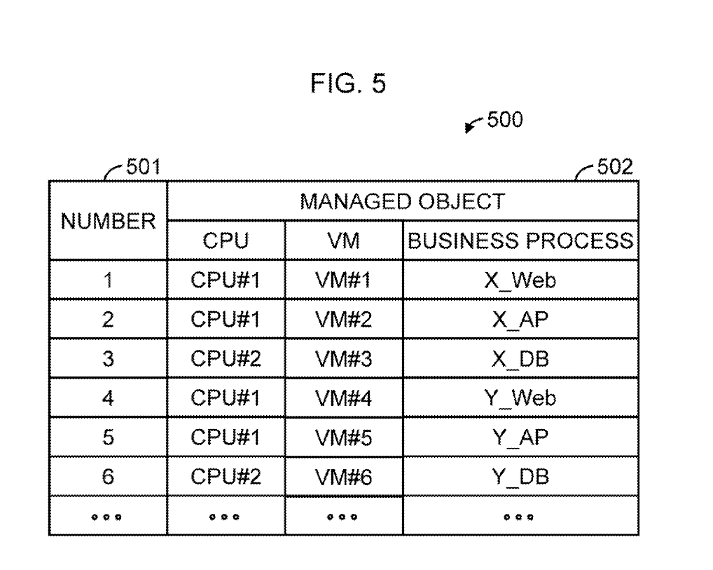

FIG. 5 illustrates an exemplary process allocation table 500 according to the embodiments. A record of the process allocation table 500 includes a “number” item 501 and a “managed object” item 502. The “number” item 501 stores a serial number of records in ascending order. The “managed object” item 502 is divided into some sections according to the types of managed objects. In FIG. 5, the “managed object” item 502 is divided into a “CPU” item, a “VM” item, and a “business process” item. Thus, the process allocation table 500 shows how the CPU group 111, the VM group 112, and the business process group 113 are allocated in the managed apparatus 101.

For example, the first record having a serial number “1” stores “CPU#1”, “VM#1”, and “X_Web” therein. The first record shows that the X_Web of the business process group 113 is allocated to the VM#1, and that the VM#1 is allocated to the CPU#1. It is assumed that the process allocation table 500 is set in advance by an administrator.

The function of the process allocation table 500 is realized using a storage device such as the ROM 302, the RAM 303, the magnetic disk 305, or the optical disk 307 illustrated in FIG. 3.

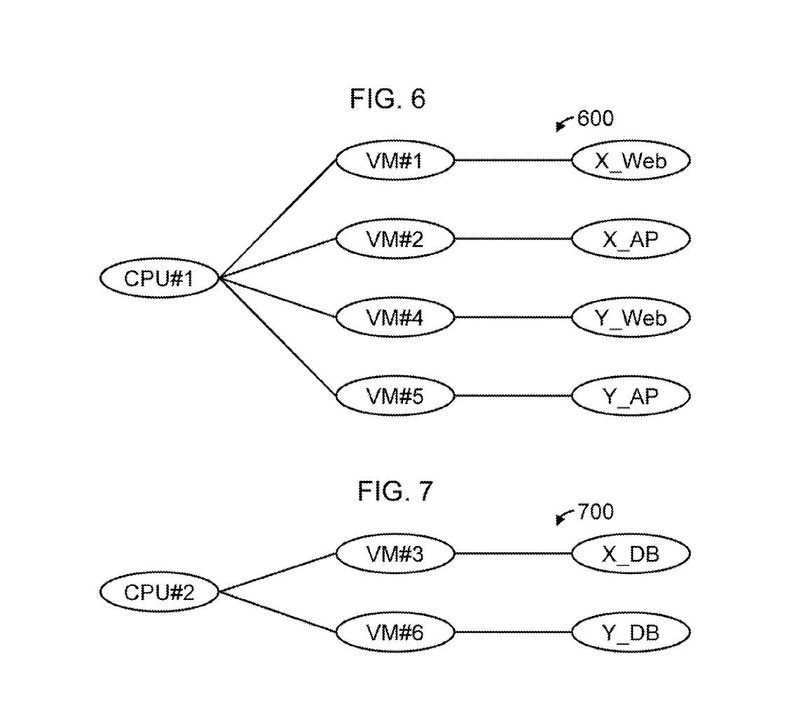

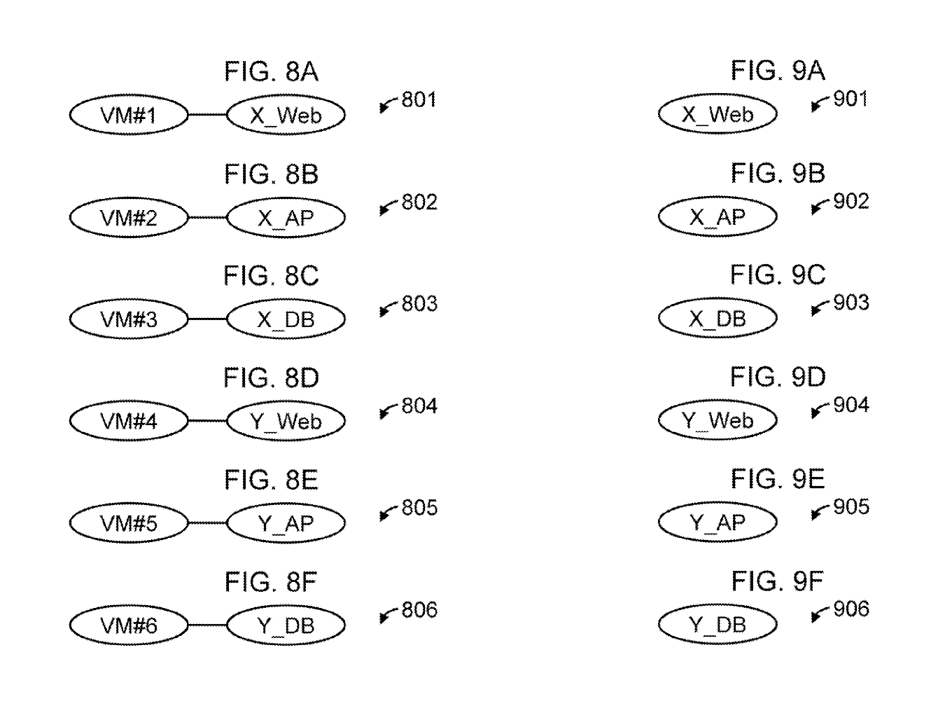

FIG. 6, FIG. 7, FIGS. 8A to 8F, and FIGS. 9A to 9F illustrate exemplary dependency information according to the embodiments. The dependency information is information that indicates how far and wide a failure that occurs at a certain managed object has an influence. Because a failure is propagated from a depended managed object to a dependent managed object, the dependency information is set for each depended managed object. In FIG. 6, FIG. 7, FIGS. 8A to 8F, and FIGS. 9A to 9F, an ellipse is a node indicating a managed object, and a link between nodes indicates a dependency between the nodes. Specifically, the left node of two nodes connected by a link is a depended managed object, and the right node is a dependent managed object. Therefore, in a piece of dependency information, the leftmost node indicates a managed object serving as a starting point of failures.

FIG. 6 and FIG. 7 illustrate dependency information in the case where the CPU group 111 has a starting point of failures. Specifically, FIG. 6 illustrates dependency information 600 in the case where the CPU#1 is a starting point of failures. FIG. 7 illustrates dependency information 700 in the case where the CPU#2 is a starting point of failures.

FIGS. 8A to 8F illustrate dependency information in the case where the VM group 112 has a starting point of failures. FIG. 8A illustrates dependency information 801 in the case where the VM#1 is a starting point of failures. FIG. 8B illustrates dependency information 802 in the case where the VM#2 is a starting point of failures. FIG. 8C illustrates dependency information 803 in the case where the VM#3 is a starting point of failures.

FIG. 8D illustrates dependency information 804 in the case where the VM#4 is a starting point of failures. FIG. 8E illustrates dependency information 805 in the case where the VM#5 is a starting point of failures. FIG. 8F illustrates dependency information 806 in the case where the VM#6 is a starting point of failures.

FIGS. 9A to 9F illustrate dependency information in the case where the business process group 113 has a starting point of failures. FIG. 9A illustrates dependency information 901 in the case where the X_Web is a starting point of failures. FIG. 9B illustrates dependency information 902 in the case where the X_AP is a starting point of failures. FIG. 9C illustrates dependency information 903 in the case where the X_DB is a starting point of failures.

FIG. 9D illustrates dependency information 904 in the case where the Y_Web is a starting point of failures. FIG. 9E illustrates dependency information 905 in the case where the Y_AP is a starting point of failures. FIG. 9F illustrates dependency information 906 in the case where the Y_DB is a starting point of failures.

Hereinafter, a pathway from a managed object of the starting point (the leftmost node) to a terminal managed object (a rightmost node) will be referred to as a route. A route is also referred to as a path. For example, the dependency information 600 illustrated in FIG. 6 has four routes, that is, a route from the CPU#1 to the X_Web via the VM#1, a route from the CPU#1 to the X_AP via the VM#2, a route from the CPU#1 to the Y_Web via the VM#4, and a route from the CPU#1 to the Y_AP via the VM#5.

As is the case with the process allocation table 500, dependency information may be set in advance by an administrator. If the dependency information is described in an extensible markup language (XML) format, it may be represented in a tree structure. When dependency information is set in advance, the dependency information extraction unit 402 extracts dependency information regarding managed objects that have dependencies with each other by using identification information of a managed object stored in the “occurrence point” item 204 of each piece of event information acquired by the event information acquisition unit 401 as a clue.

For example, if identification information (“CPU#1”, for example) of a managed object belonging to the CPU group 111 is stored in the “occurrence point” item 204 of a piece of acquired event information, the dependency information 600 illustrated in FIG. 6 is extracted from among plural pieces of dependency information.

If identification information (“VM#2”, for example) of a managed object belonging to the VM group 112 is stored in the “occurrence point” item 204 of a piece of acquired event information, but identification information of a managed object belonging to the CPU group 111 is not stored in the “occurrence point” item 204 of any pieces of acquired event information, the dependency information 802 illustrated in FIG. 8B is extracted from among plural pieces of dependency information.

If identification information (“X_DB”, for example) of a managed object belonging to the business process group 113 is stored in the “occurrence point” item 204 of a piece of acquired event information, but neither identification information of a managed object belonging to the CPU group 111 nor identification information of a managed object belonging to the VM group 112 is stored in the “occurrence point” item 204 of any pieces of acquired event information, the dependency information 903 illustrated in FIG. 9C is extracted from among plural pieces of dependency information.

Alternatively, without setting dependency information in advance, the relevant dependency information may be determined by causing the dependency information extraction unit 402 to search the process allocation table 500. Specifically, it may be realized, for example, by creating the process allocation table 500 in a relational DB in advance and executing a preset search formula written in the structured query language (SQL) on the process allocation table 500 in order to identify the relevant dependency information. A resultant set (in a tabular format) obtained by the above operations may be determined as the relevant dependency information.

determining the relevant dependency information by searching the process allocation table 500 removes the burden of creating dependency information in advance. In addition, because the relevant dependency information may be written to the memory every time the process allocation table 500 is searched, it is not necessary to prepare all pieces of dependency information, resulting in a decrease in the usage of the memory.

Here, the plural pieces of dependency information 600, 700, 801 to 806, and 901 to 906 are realized by using storage devices such as the ROM 302, the RAM 303, the magnetic disk 305, and the optical disk 307 in FIG. 3.

The node combination extraction unit 403 illustrated in FIG. 4 has a function of extracting a combination of nodes, that is, a depended managed object and a dependent managed object which depends on the depended managed object, on the basis of the dependency information extracted by the dependency information extraction unit 402.

Specifically, the node combination extraction unit 403 extracts a combination of nodes that are connected to both ends of each link included in the relevant dependency information. For example, in the case of the dependency information 600 illustrated in FIG. 6, eight combinations may be extracted, that is, a combination of the CPU#1 and the VM#1, a combination of the VM#1 and the X_Web, a combination of the CPU#1 and VM#2, a combination of the VM#2 and the X_AP, a combination of the CPU#1 and the VM#4, a combination of the VM#4 and the Y_Web, a combination of the CPU#1 and the VM#5, and a combination of the VM#5 and the Y_AP.

The event dependency determination unit 404 has a function of performing an event dependency determination process, that is, determining, for each combination of nodes extracted by the node combination extraction unit 403, whether there is a dependency between a first event and a second event on the basis of a difference between an occurrence time of the first event and an occurrence time of the second event. The first event has occurred at the depended managed object and the second event has occurred at the dependent managed object which depends on the depended managed object.

Specifically, the event dependency determination unit 404 reads out the occurrence time of the first event from the “time stamp” item of corresponding event information. In a similar way, the event dependency determination unit 404 reads out the occurrence time of the second event from the “time stamp” item of corresponding event information. Then, the event dependency determination unit 404 calculates the difference between both time stamps (between both occurrence times).

An absolute value of the time difference between both time stamps is used as the difference. Usually, the event occurred at the depended managed object is detected earlier than the event occurred at the dependent managed object. However, there is a case where the event occurred at the dependent managed object is detected earlier for some reason. Therefore, the absolute value of the time difference between both time stamps is used as the difference. When the difference is equal to or smaller than a threshold Ts, the event dependency determination unit 404 determines that there is a failure dependency between the two events. When the difference is larger than a threshold Ts, the event dependency determination unit 404 determines that there is no failure dependency between the two events.

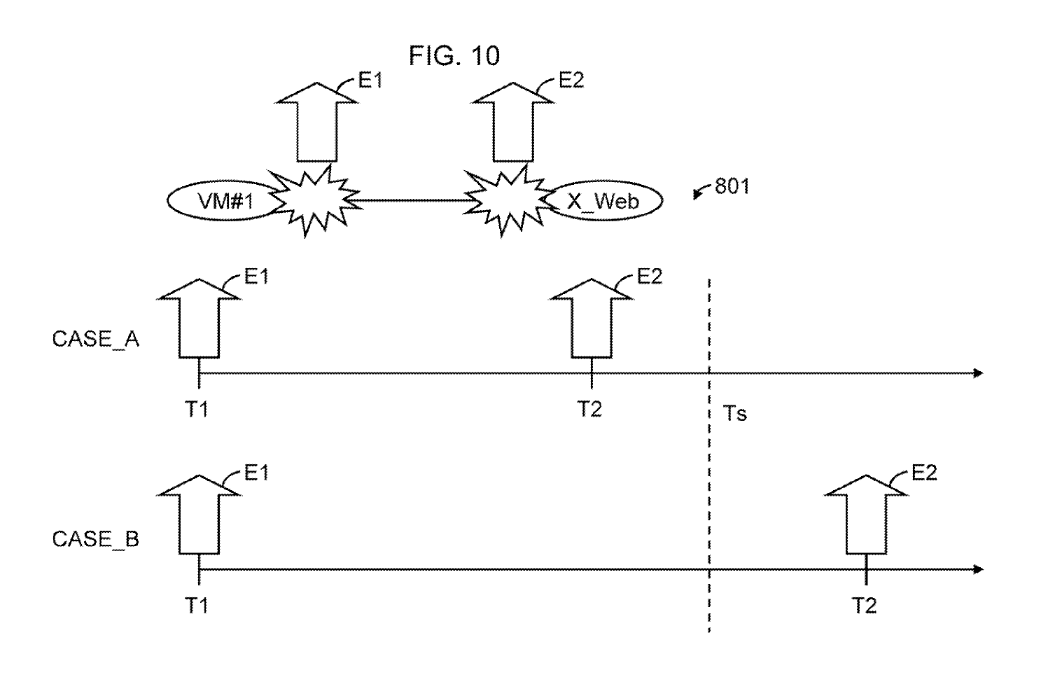

FIG. 10 illustrates a first concrete example of the event dependency determination process performed by the event dependency determination unit 404. In FIG. 10, a combination of VM#1 and X_Web represented by dependency information 801 illustrated in FIG. 8A is taken as an example. It is assumed that an event E1 occurs at time T1 at the VM#1 and an event E2 occurs at time T2 at the X_Web.

In CASE_A of FIG. 10, because the difference |T2−T1|≦Ts, it is determined that the event E1 and the event E2 have a failure dependency with each other. In CASE_B of FIG. 10, because the difference |T2−T1|>Ts, it is determined that the event E1 and the event E2 have no failure dependency with each other.

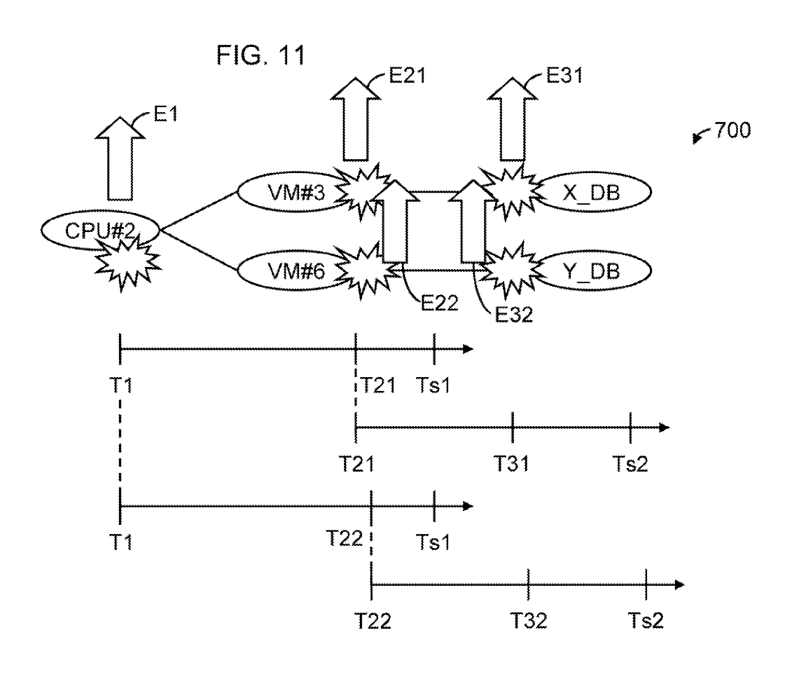

FIG. 11 illustrates a second concrete example of the event dependency determination process performed by the event dependency determination unit 404. In FIG. 11, four combinations acquired from the dependency information 700 illustrated in FIG. 7 are taken as examples, that is, a combination of the CPU#2 and VM#3, a combination of the VM#3 and the X_DB, a combination of the CPU#2 and the VM#6, and a combination of the VM#6 and the Y_DB. It is assumed that an event E1 occurs at time T1 at the CPU#2, an event E21 occurs at time T21 at the VM#3, an event E31 occurs at time T31 at the X_DB, an event E22 occurs at time T22 at the VM#6, and an event E32 occurs at time T32 at the Y_DB.

In addition, it is assumed that the threshold Ts between the CPU group 111 and the VM group 112 is denoted by Ts1, and the threshold Ts between the VM group 112 and the business process group 113 is denoted by Ts2. The thresholds Ts1 and Ts2 may be arbitrarily set by an administrator, and they may be set as Ts1=Ts2 or Ts1≠Ts2.

In the present example, because the four combinations, that is, the combination of the CPU#2 and VM#3, the combination of the VM#3 and the X_DB, the combination of the CPU#2 and the VM#6, and the combination of the VM#6 and the Y_DB are extracted, the corresponding differences |T21−T1|, |T31−T21|, |T22−T1|, and |T32−T22| are calculated, and whether these differences are within the corresponding threshold Ts1 or Ts2 is determined. In the example of FIG. 11, all the differences |T21−T1|, |T31−T21|, |T22−T1|, and |T32−T22| are within the corresponding threshold Ts1 or Ts2. Therefore, it is determined that the events E1, E21, E31, E22, and E32 have dependencies.

The event dependency determination unit 404 may determine a dependency even if an event at a midway point or an event at the starting point is not reported. The concrete example of this process of the event dependency determination unit 404 will be discussed later.

The starting-point determination unit 405 illustrated in FIG. 4 has a function of performing a starting-point determination process, that is, selecting an event, from among events corresponding to the plural pieces of event information acquired by the event information acquisition unit 401, that occurs at a managed object that becomes a depended managed object but does not become a dependent managed object on the basis of the determination result determined by the event dependency determination unit 404, and determining event information regarding the selected event as event information to be preserved.

Specifically, if the event dependency determination unit 404 has determined that all the combinations of the events have dependencies, the starting-point determination unit 405 selects the event that has occurred at a managed object that becomes a depended managed object but does not become a dependent managed object and determines event information regarding the selected event as event information to be preserved. For example, because the leftmost managed object in a piece of dependency information is a depended managed object that does not become a dependent managed object, the leftmost managed object in the piece of dependency information becomes a starting point of failures. Therefore, the starting-point determination unit 405 determines event information regarding an event that occurs at a managed object that is the leftmost node in a piece of dependency information as event information to be preserved.

For example, in CASE_A of FIG. 10, the starting-point determination unit 405 determines event information regarding the event E1 that has occurred at VM#1 as event information to be preserved. Event information regarding the event E1 among two events E1 and E2 is determined as event information to be preserved, which results in 50% decrease in the usage of the memory compared with the case where both pieces of event information are preserved.

In the example illustrated in FIG. 11, the starting-point determination unit 405 determines event information regarding the event E1 that has occurred at the CPU#2 as event information to be preserved. Therefore, an 80% decrease in the usage of the memory is achieved compared with the case where event information regarding five events E1, E21, E31, E22, and E32 are preserved.

If the event dependency determination unit 404 has determined that a combination of events have no dependency with each other, the starting-point determination unit 405 determines event information regarding each of the combination of events as event information to be preserved. For example, in CASE_B of FIG. 10, because the events E1 and E2 have no dependency with each other, the starting-point determination unit 405 determines event information regarding each of the events E1 and E2 as event information to be preserved.

The reliability calculation unit 406 has a function of calculating a degree of reliability regarding the event information to be preserved on the basis of a total number of combinations and the number of combinations for which corresponding first event and second event are detected. The degree of reliability is an index value for evaluating the reliability of a determination result indicating dependencies between events determined by the event dependency determination unit 404. For example, the degree of reliability is a value given by dividing the number of combinations for which corresponding first event and second event are detected by the total number of combinations.

For example, in the CASE_A of FIG. 10, the number of combinations is one, that is, the combination of the VM#1 and the X_Web, therefore the total number is also one. Because the event E1 occurred at the VM#1 and the event E2 occurred at the X_Web are detected, the number of combinations for which corresponding first event and the second event are detected is one. Therefore, the degree of reliability is 1/1. In a similar way, the degree of reliability in the case of FIG. 11 is 4/4.

The starting-point determination unit 405 may determine event information to be preserved on the basis of the degree of reliability calculated by the reliability calculation unit 406. For example, it is assumed that a predetermined reliability P is set as a threshold. The value of the predetermined reliability P may be set arbitrarily by an administrator.

If the degree of the reliability calculated by the reliability calculation unit 406 is equal to or larger than the predetermined reliability P, event information regarding an event (an event that is a starting point of failures), among the events that are determined to have dependencies with each other by the event dependency determination unit 404, that occurs at a managed object that becomes a depended managed object but does not become a dependent managed object is determined as event information to be preserved. On the other hand, if the degree of reliability calculated by the reliability calculation unit 406 is smaller than the predetermined reliability P, event information regarding each event among the events that are determined to have dependencies with each other by the event dependency determination unit 404 is determined as event information to be preserved.

For example, if the predetermined reliability P is set to be 70%, the degree of reliability 1/1 in CASE_A of FIG. 10 is larger than the predetermined reliability P, therefore event information regarding the event E1 is determined as event information to be preserved. The degree of reliability 4/4 in the case of FIG. 11 is larger than the predetermined reliability P, therefore event information regarding the event E1 is determined as event information to be preserved.

The event information preservation unit 407 illustrated in FIG. 4 has a function of preserving in the DB 408 the event information determined by the starting-point determination unit 405 to be preserved. Specifically, pieces of information included in event information to be preserved, such as the “number” item, the “time stamp” item, the “event type” item, the “occurrence point” item, the “alarm type” item, and the “reservation” item, are preserved in the integrated management DB 103 as a record.

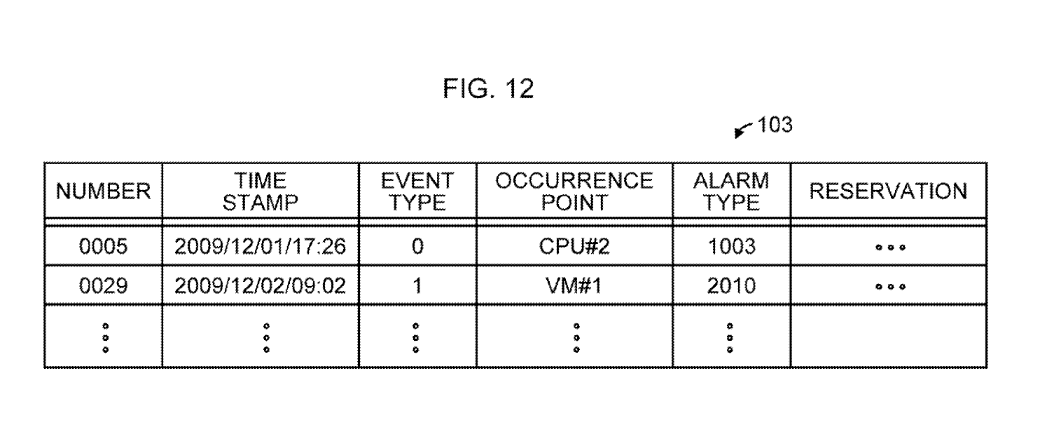

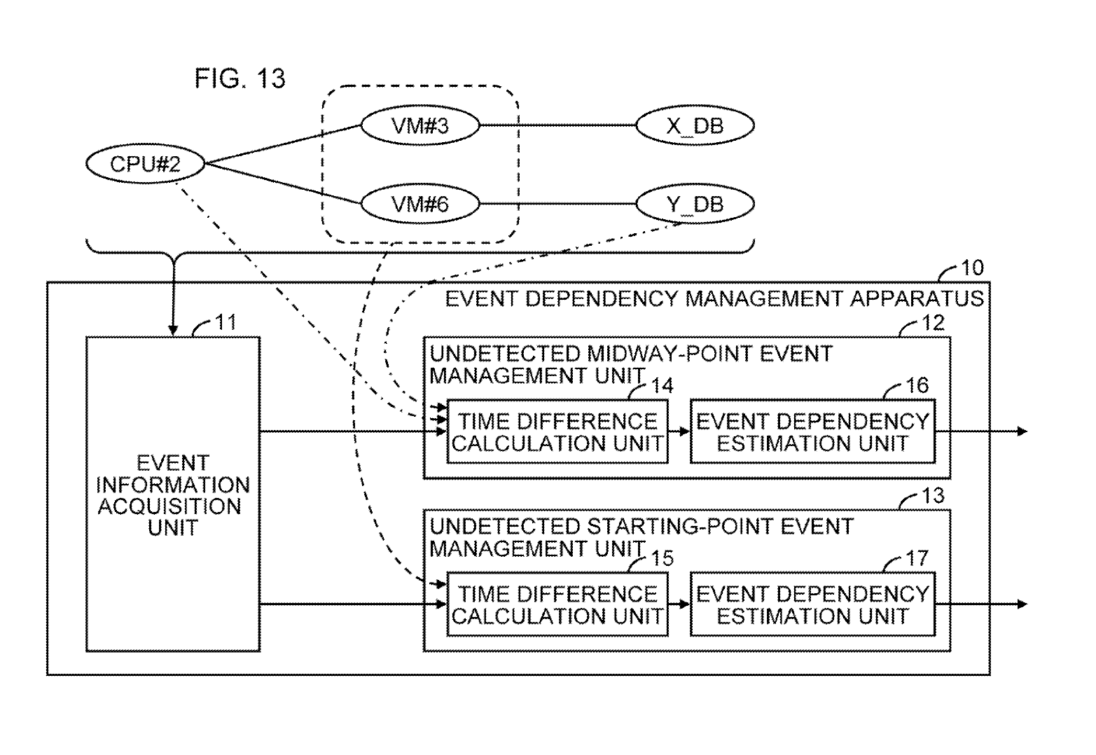

FIG. 12 illustrates an exemplary integrated management DB 103 according to the embodiments. Although the event information preservation unit 407 may preserve all pieces of information included in the event information to be preserved, it is all right for the event information preservation unit 407 to preserve at least the “number” item and the “occurrence point” item. It is possible to retrieve other pieces of information from the DBs 124 to 126 by using the preserved “number” item and the preserved “occurrence point” item.

The event information preservation unit 407 may preserve the degree of reliability calculated by the reliability calculation unit 406. In this case, the degree of reliability may be preserved in the “reservation” item 206 of the integrated management DB 103.

### First Embodiment

FIG. 13 illustrates an exemplary event dependency management apparatus according to a first embodiment. An event dependency management apparatus 10 illustrated in FIG. 13 is part of the integrated management function 127 illustrated in FIG. 1. It is assumed that the event dependency management apparatus 10 manages the CPU#2, the VM#3, the VM#6, the X_DB, and the Y_DB.

The CPU#2 is a first managed object for the event dependency management apparatus 10 to manage. The VM#3 and the VM#6 are second managed objects for the event dependency management apparatus 10 to manage. The X_DB and the Y_DB are third managed objects for the event dependency management apparatus 10 to manage.

There are dependencies between the CPU#2 and the VM#3, and between the CPU#2 and the VM#6, respectively. In these dependencies, the VM#3 and the VM#6 depend on the CPU#2. In other words, if a failure occurs at the CPU#2, a failure may occur at the VM#3 or in the VM#6.

There is a dependency between the VM#3 and the X_DB. In this dependency, the X_DB depends on the VM#3. In other words, if a failure occurs at the VM#3, a failure may occur at the X_DB.

There is a dependency between the VM#6 and the Y_DB. In this dependency, the Y_DB depends on the VM#6. In other words, if a failure occurs at the VM#6, a failure may occur at the Y_DB.

Therefore, it is conceivable that, owing to the dependency between the CPU#2 and the VM#3, the dependency between the CPU#2 and the VM#6, the dependency between the VM#3 and the X_DB, and the dependency between the VM#6 and the Y_DB, a failure that has occurred at the CPU#2 may cause a failure at the VM#3, at the VM#6, at the X_DB, or at the Y_DB.

If an event that occurs at a depended managed object and an event that occurs at a dependent managed object are detected and the difference between the occurrence times of these events is smaller than a predetermined time period, it may be determined that these two events are brought about by the dependency between the above two managed objects and that these two events have a dependency with each other. Such a dependency between events may be used for the management of event information. For example, there may be a case where information regarding events at starting points is selectively collected and preserved considering that depended events are more important than dependent events.

As discussed above, because it is important to know a dependency between events, it may be useful to determine a dependency relating to an event that has failed to be detected.

For this purpose, the event dependency management apparatus 10 according to the present embodiment includes an undetected midway-point event management unit 12 that estimates an undetected event occurred at a midway point and an undetected starting-point event management unit 13 that estimates an undetected event occurred at a starting point, as well as an event information acquisition unit 11 that acquires event information from managed objects.

The undetected midway-point event management unit 12 includes a time difference calculation unit 14 and an event dependency estimation unit 16. The time difference calculation unit 14 calculates a difference between an occurrence time of an event that occurs at the CPU#2 that is the first managed object and an occurrence time of an event that occurs at the X_DB that is one of the third managed objects, and a difference between an occurrence time of an event that occurs at the CPU#2 and an occurrence time of an event that occurs at the Y_DB that is another one of the third managed objects. If the differences calculated by the time difference calculation unit 14 are smaller than predetermined time periods, the event dependency estimation unit 16 determines that the events occurred at the X_DB and at the Y_DB have occurred in dependence upon an event occurred at the CPU#2.

The undetected starting-point event management unit 13 includes a time difference calculation unit 15 and an event dependency estimation unit 17. The time difference calculation unit 15 calculates a difference between an occurrence time of an event that occurs at the VM#3 that is one of the second managed objects and an occurrence time of an event that occurs at the VM#6 that is another one of the second managed objects. If the difference calculated by the time difference calculation unit 15 is smaller than a predetermined time period, the event dependency estimation unit 17 determines that the events occurred at the VM#3 and at the VM#6 have occurred in dependence upon an event occurred at the CPU#2.

Concrete Example of Undetected Midway-Point Event

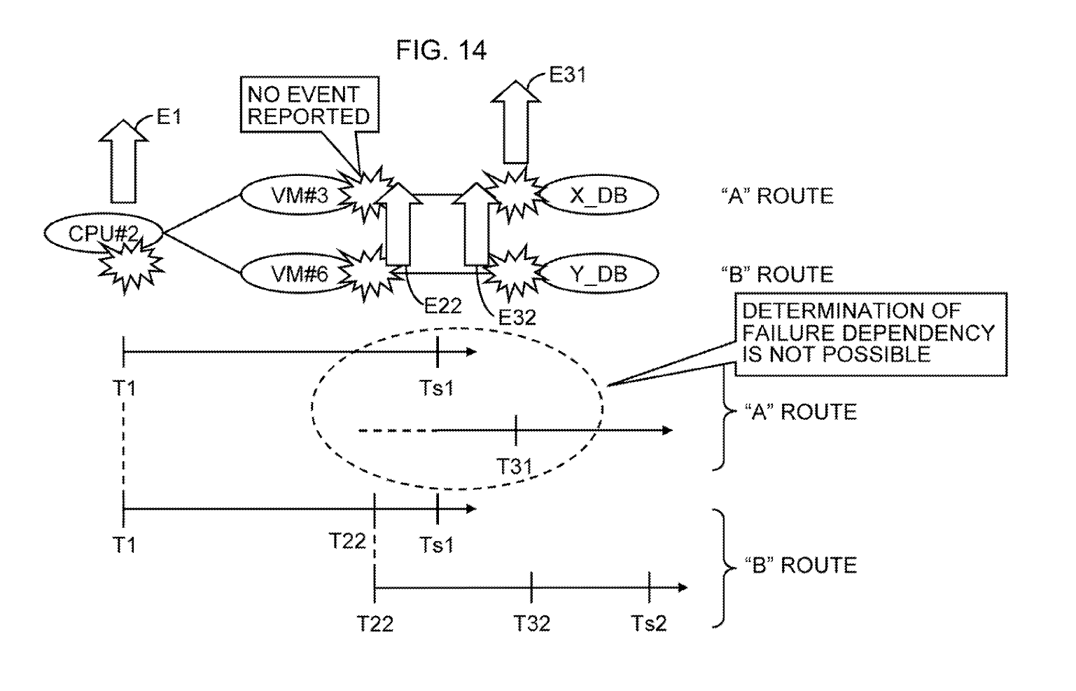

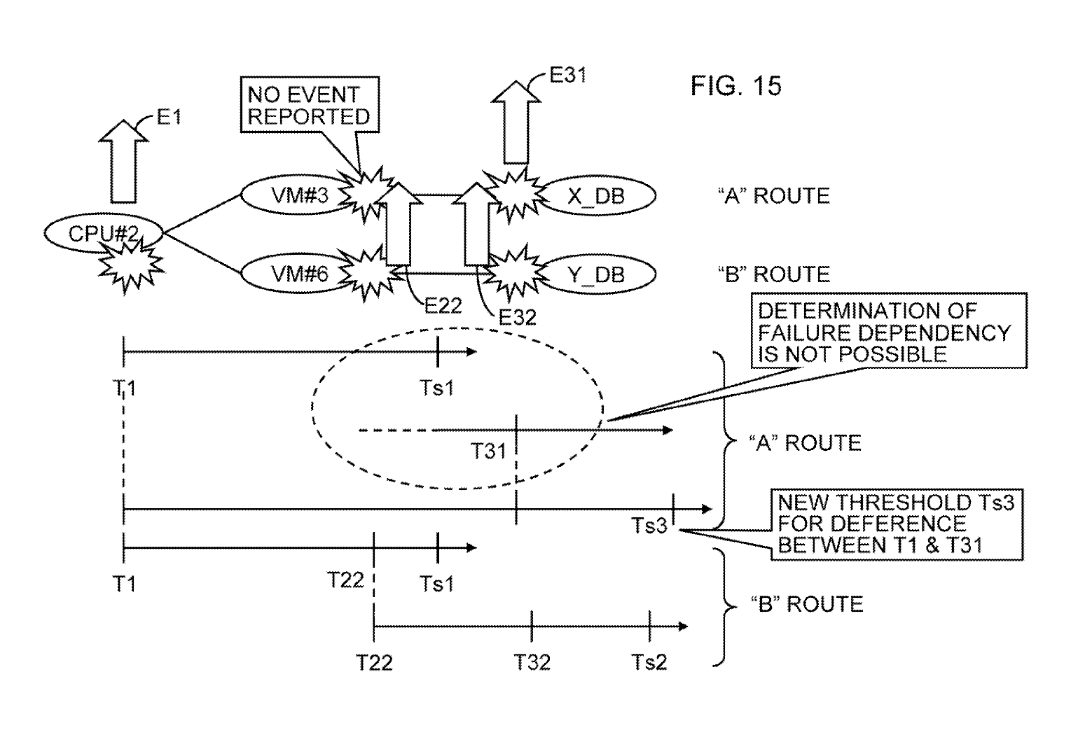

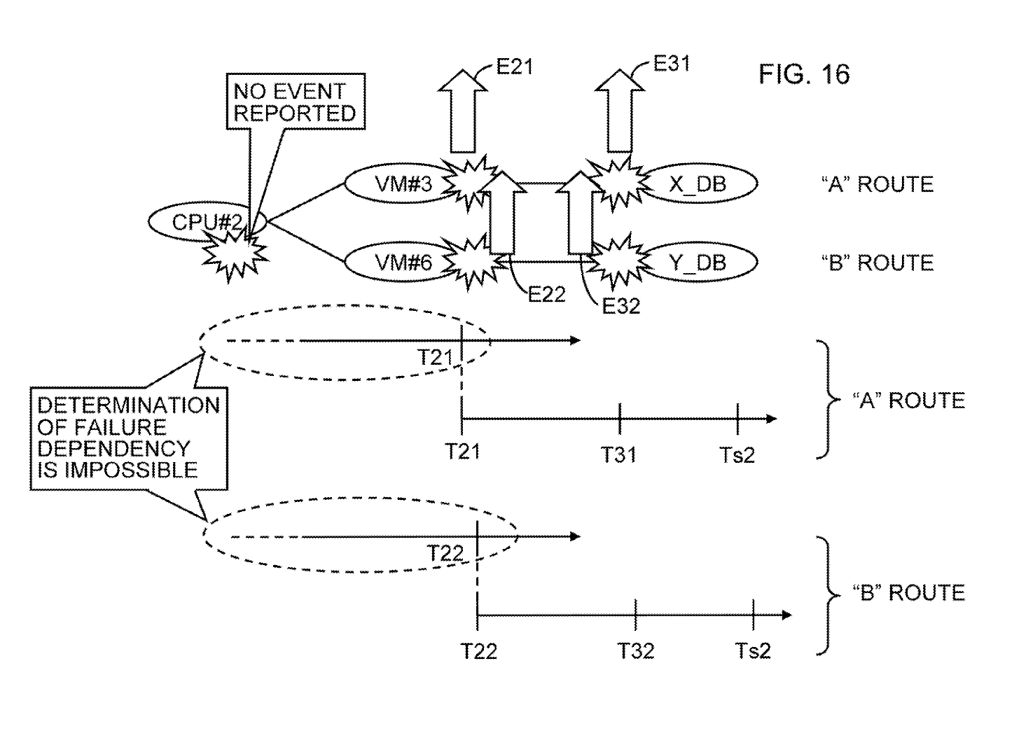

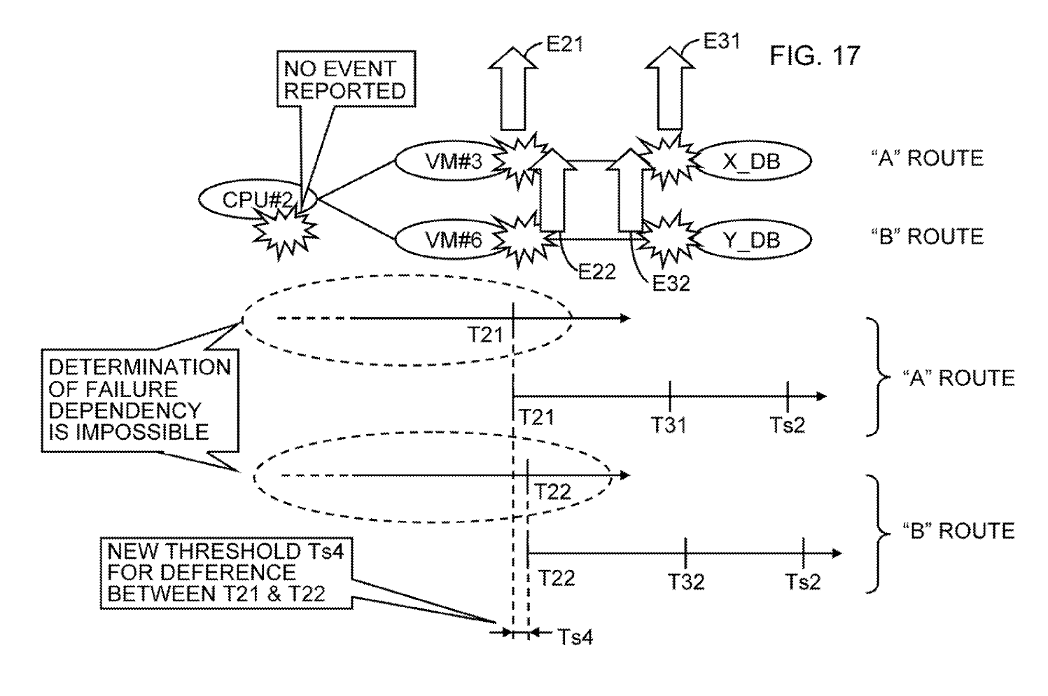

A concrete example of operations of the undetected midway-point event management unit 12 will be discussed below. FIG. 14 illustrates a concrete example of an undetected event occurred at a midway point. Hereinafter, an undetected event that has occurred at a midway point will be referred to as an undetected midway-point event. FIG. 15 illustrates a concrete example of estimation of an event dependency relating to an undetected midway-point event. In FIGS. 14 and 15, a route from the CPU#2 to the X_DB via the VM#3 will be referred to as “A” route, and a route from the CPU#2 to the Y_DB via the VM#6 will be referred to as “B” route.

In the example of FIG. 14, the occurrence of an event E1 at the time T1 is reported from the CPU#2. The occurrence of an event E31 at the time T31 is reported from the X_DB. The occurrence of an event E22 at the time T22 is reported from the VM#6. The occurrence of an event E32 at the time T32 is reported from the Y_DB. However, the occurrence of any event is not reported from the VM#3.

In “B” route, because the difference between the time T1 and the time T22 is smaller than a threshold Ts1, it may be determined that the event E22 has occurred in dependence upon the event E1. Because the difference between the time T22 and the time T32 is smaller than a threshold Ts2, it may be determined that the event E32 has occurred in dependence upon the event E22.

However, in “A” route, because the occurrence of any event is not reported from the VM#3, it is impossible to determine whether there is a failure dependency on the basis of an event reported from the VM#3.

To cope with this problem, the undetected midway-point event management unit 12 determines whether there is a failure dependency between the failures by using a threshold Ts3 which is used for determining the failure dependency on the basis of an occurrence time of an event in the CPU#2 that is the first managed object and an occurrence time of an event in the X_DB that is one of the third managed objects as illustrated in FIG. 15. That is, if a difference between the time T1 and the time T31 is smaller than the threshold Ts3, the undetected midway-point event management unit 12 may estimate that the event E31 has occurred in dependence upon the event E1 without any event information reported from the VM#3 at a midway point of “A” route.

Concrete Example of Undetected Starting-Point Event

A concrete example of operations of the undetected starting-point event management unit 13 will be discussed below. FIG. 16 illustrates a concrete example of an undetected event occurred at a starting point. Hereinafter, an undetected event that has occurred at a starting point will be referred to as an undetected starting-point event. FIG. 17 illustrates a concrete example of estimation of an event dependency relating to an undetected starting-point event. In FIGS. 16 and 17, a route from the CPU#2 to the X_DB via the VM#3 will be referred to as “A” route, and a route from the CPU#2 to the Y_DB via the VM#6 will be referred to as “B” route.

In the example of FIG. 16, the occurrence of an event E21 at the time T21 is reported from the VM#3. The occurrence of an event E31 at the time T31 is reported from the X_DB. The occurrence of an event E22 at the time T22 is reported from the VM#6. The occurrence of an event E32 at the time T32 is reported from the Y_DB. However, the occurrence of any event is not reported from the CPU#2.

In “A” route, because the difference between the time T21 and the time T31 is smaller than the threshold Ts2, it may be determined that the event E31 has occurred in dependence upon the event E21. In “B” route, because the difference between the time T22 and the time T32 is smaller than the threshold Ts2, it may be determined that the event E32 has occurred in dependence upon the event E22.

However, because the occurrence of any event is not reported from the CPU#2, it seems that the VM#3 and the VM#6 are starting points of the events.

To cope with this problem, the undetected starting-point event management unit 13 determines whether there is a failure dependency between the failures by using a threshold Ts4 which is used for determining the failure dependency on the basis of the occurrence time of the event in the VM#3 that is one of the second managed objects and the occurrence time of the event in the VM#6 that is another one of the second managed objects. That is, if a difference between the time T21 and the time T22 is smaller than the threshold Ts4, the undetected starting-point event management unit 13 may estimate that the events E21 and E22 have occurred in dependence upon an event occurred at the CPU#2 without any event information reported from the CPU#2 at the starting point.

In the estimation, the undetected starting-point event management unit 13 may also use event information reported from third managed objects. Specifically, in the example of FIG. 17, because a difference between the time T21 and the time T31 is smaller than the threshold Ts2, it may be determined that the event E31 has occurred in dependence upon the event E21 in “A” route. In addition, because a difference between the time T22 and the time T32 is smaller than the threshold Ts2, it may be determined that the event E32 has occurred in dependence upon the event E22 in “B” route. Because the events occurred at the second managed objects and the events occurred at the third managed objects have dependencies in both two routes having CPU#2 as the starting point, it may be determined that the CPU#2 is the starting point of these events.

In the case where it is determined that plural second events have occurred in dependence upon a first event, the event dependency estimation unit 17 may generate a dummy value for the occurrence time of the first event. Specifically, the dummy value for the occurrence time of the first event may be set to be a value obtained by subtracting a predetermined time from of the occurrence time of one of the second events. The predetermined time may be arbitrary, for example, Ts1.

As discussed above, according to the present embodiment, the event dependency management apparatus 10 calculates a difference between the occurrence times of a first event and a third event, and determines that the third event has occurred in dependence upon the first event if the difference is smaller than the threshold Ts3. The event dependency management apparatus 10 determines that plural second events have occurred in dependence upon a first event if differences between occurrence times of the plural second events are smaller than the threshold Ts4. Therefore, the event dependency management apparatus 10 according to the present embodiment may determine whether there is a failure dependency even if there is an undetected event.

Event Information Management Procedure

An event information management procedure performed by the event information management apparatus 400 illustrated in FIG. 4 will be discussed below.

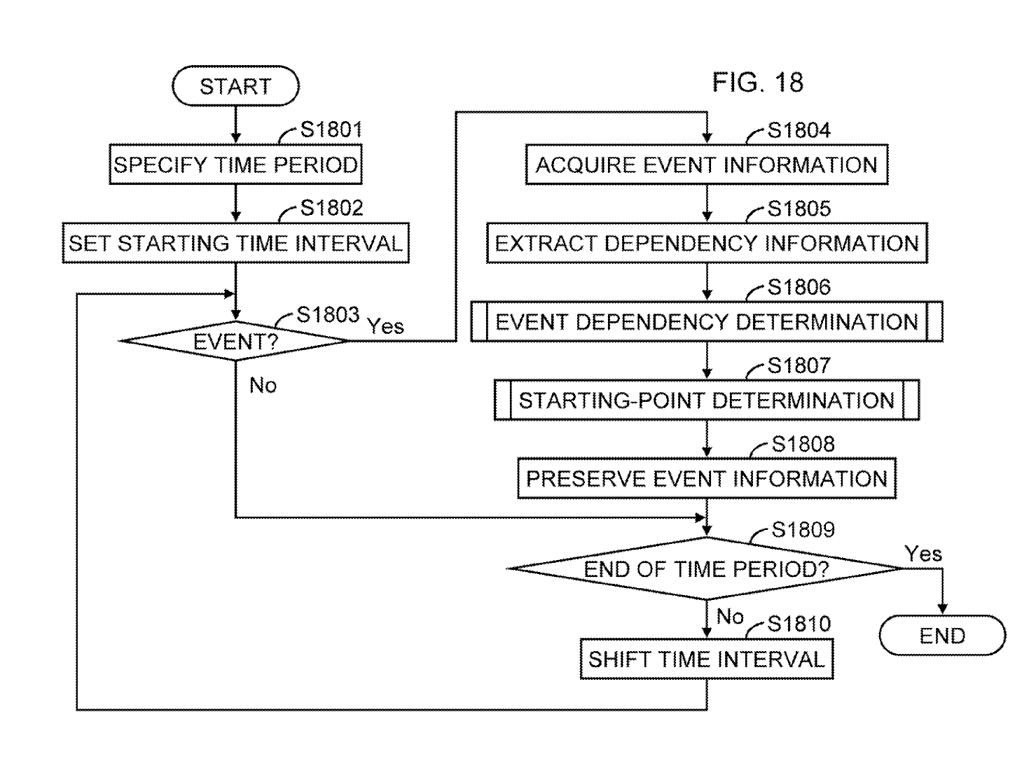

FIG. 18 illustrates exemplary operation flow of an event information management procedure performed by the event information management apparatus 400 according to the present embodiment.

In S1801, the event information management apparatus 400 specifies a targeted time period as initial setting.

In S1802, the event information management apparatus 400 sets a targeted time interval as a starting time interval in the targeted time period.

In S1803, the event information management apparatus 400 determines whether there are any events occurred in the targeted time interval with reference to the DBs 124 to 126.

In S1804, when there are any events occurred in the targeted time interval (“Yes” in S1803), the event information acquisition unit 401 acquires event information regarding the events occurred in the targeted time interval from the DBs 124 to 126.

In S1805, the dependency information extraction unit 402 extracts dependency information corresponding to the acquired event information.

In S1806, the event dependency determination unit 404 performs the event dependency determination process.

In S1807, the starting-point determination unit 405 performs the starting-point determination process for determining the starting point of failures.

In S1808, the event information preservation unit 407 preserves event information regarding the event occurred at the determined starting point in the DB 408, i.e., the integrated management DB 103.

In S1809, the event information management apparatus 400 determines whether the management procedure all over the targeted time period has been completed.

In S1810, when the management procedure all over the targeted time period has not been completed (“No” in S1809), the event information management apparatus 400 shifts the targeted time interval so as to perform the management procedure for the next time interval, and returns the procedure to S1803. Because there is a possibility that an event is reported during a time-gap between the current time interval and the next time interval, it would be reasonable to partly overlap adjacent time intervals with each other.

When there is no event occurred in the targeted time interval (“No” in S1803), the event information management apparatus 400 advances the procedure to S1809. When the management procedure all over the targeted time period has been completed (“Yes” in S1809), the event information management apparatus 400 terminates the management procedure.

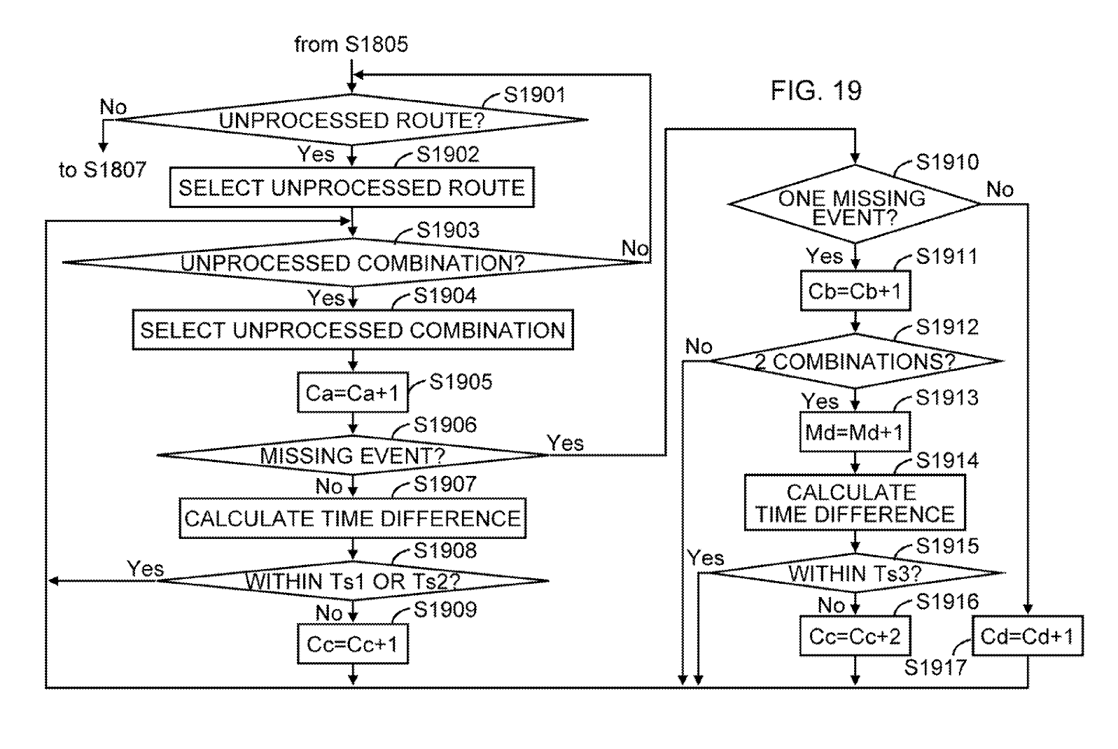

FIG. 19 illustrates an exemplary detailed operation flow of the event dependency determination process of S1806 in FIG. 18.

In S1901, the event information management apparatus 400 determines whether there is a route (referred to as an unprocessed route), among the dependency information extracted in S1805, on which the event dependency determination process is not performed. When there is no unprocessed route (“No” in S1901), the event information management apparatus 400 advances the procedure to the starting-point determination process (S1807).

In S1902, when there is an unprocessed route (“Yes” in S1901), the event information management apparatus 400 selects the unprocessed route. For example, in the case of the dependency information 700 illustrated in FIG. 11, the event information management apparatus 400 selects an unprocessed route out of two routes, that is, the route from the CPU#2 to the X_DB via the VM#3 and the route from the CPU#2 to the Y_DB via the VM#6.

In S1903, the event information management apparatus 400 determines whether there is a combination (referred to as an unprocessed combination) of nodes on which the event dependency determination process is not performed in the selected route. A combination of nodes is a combination of a first event that has occurred at a depended managed object and a second event that has occurred at a dependent managed object, among the events that have occurred at managed objects that have dependencies with each other. In other words, the nodes in the combination are combined with each other by a link. When there is no unprocessed combination of nodes (“No” in S1903), the event information management apparatus 400 returns the process to S1901.

In S1904, when there is an unprocessed combination of nodes (“Yes” in S1903), the event information management apparatus 400 selects the unprocessed combination of nodes. For example, in the case of the dependency information 600 illustrated in FIG. 6, the event information management apparatus 400 selects an unprocessed combination of nodes out of eight combinations, that is, the combination of the CPU#1 and the VM#1, the combination of the VM#1 and the X_Web, the combination of the CPU#1 and the VM#2, the combination of the VM#2 and the X_AP, the combination of the CPU#1 and the VM#4, the combination of the VM#4 and the Y_Web, the combination of the CPU#1 and the VM#5, and the combination of the VM#5 and the Y_AP.

In S1905, the event information management apparatus 400 increments a counter Ca (the initial value thereof is Ca=0) that counts the total number of selected combinations of nodes.

In S1906, the event information management apparatus 400 determines whether there are any missing events in the selected combination of nodes.

In S1907, when there is no missing event (“No” in S1906), the event information management apparatus 400 reads out a time stamp of an event occurred at each managed object in the selected combination of nodes, and calculates the difference between the time stamps.

In S1908, the event information management apparatus 400 determines whether the difference is equal to or smaller than the corresponding threshold Ts1 or Ts2. When the difference is equal to or smaller than the corresponding threshold Ts1 or Ts2 (“Yes” in S1908), it indicates that there is a dependency, and the event information management apparatus 400 returns the process to S1903.

In S1909, when the difference is larger than the corresponding threshold Ts1 or Ts2 (“No” in S1908), it indicates that there is no dependency, and the event information management apparatus 400 increments a counter Cc (the initial value thereof is Cc=0) that counts the number of combinations that have no dependency. Thereafter, the event information management apparatus 400 returns the process to S1903.

In S1910, when it is determined that there are some missing events (“Yes” in S1906), the event information management apparatus 400 determines whether the number of missing events is one.

In S1911, when it is determined that the number of missing events is one (“Yes” in S1910), the event information management apparatus 400 increments a counter Cb (the initial value thereof is Cb=0) that counts the number of combinations in which only one event is missing.

In S1912, the event information management apparatus 400 determines whether two combinations have been prepared. When two combinations have not yet been prepared (“No” in S1912), the event information management apparatus 400 returns the process to S1903.

In S1913, when two combinations have been prepared (“Yes” in S1912), the event information management apparatus 400 increments a counter Md (the initial value thereof is Md=0) for distinguish a missing starting-point event.

In S1914, the event information management apparatus 400 reads out the time stamps of the two events included in the two combinations, and calculates a difference between the time stamps.

In S1915, the event information management apparatus 400 determines whether the difference is equal to or smaller than the threshold Ts3. When the difference is equal to or smaller than the threshold Ts3 (“Yes” in S1915), the event information management apparatus 400 returns the process to S1903.

In S1916, when the difference is larger than the threshold Ts3 (“No” in S1915), the event information management apparatus 400 adds 2 to the counter Cc, and returns the process to S1903.

In S1917, when the number of missing events is not one (“No” in S1910), the event information management apparatus 400 increments a counter Cd (the initial value thereof is Cd=0) that counts the number of combinations in which both of two events are missing, and the event information management apparatus 400 returns the process to S1903.

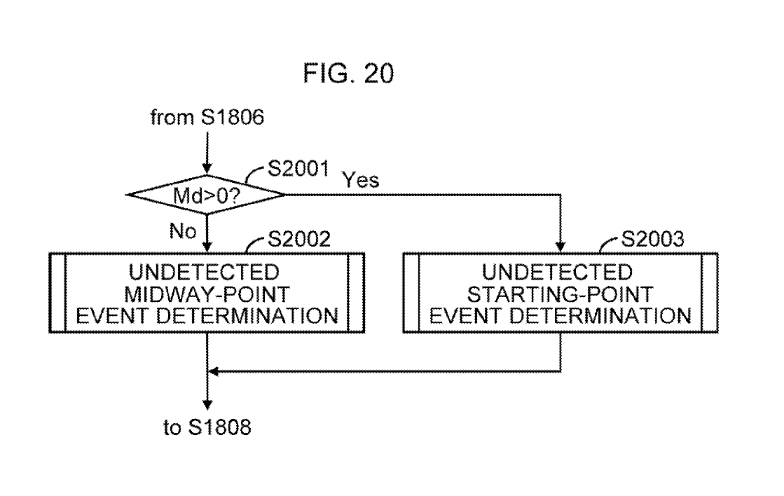

FIG. 20 illustrates an exemplary detailed operation flow of the starting-point determination process of S1807 in FIG. 18.

In S2001, the event information management apparatus 400 determines whether the value of the counter Md is positive.

In S2002, when the value of the counter Md is not positive (“No” in S2001), the event information management apparatus 400 performs an undetected midway-point event determination process, and advances the procedure to S1808.

In S2003, when the value of the counter Md is positive (“Yes” in S2001), the event information management apparatus 400 performs an undetected starting-point event determination process, and advances the procedure to S1808.

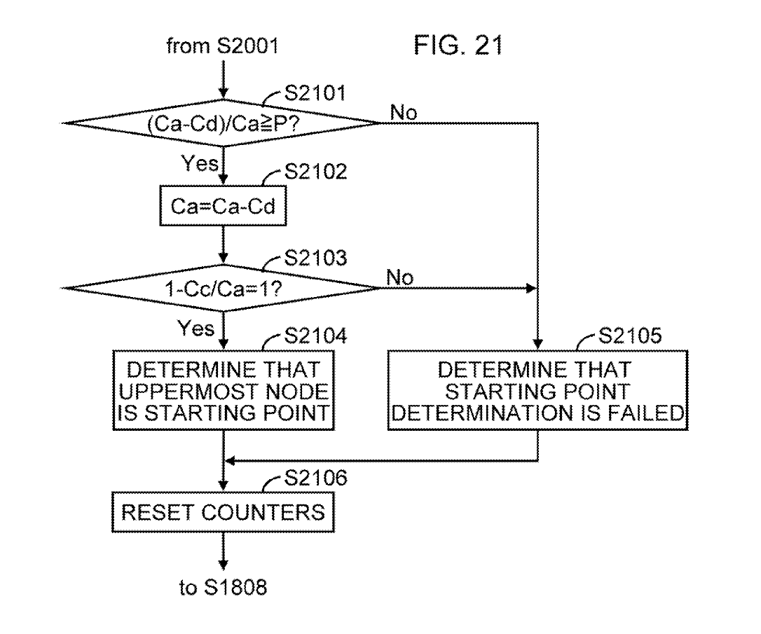

FIG. 21 illustrates an exemplary detailed operation flow of the undetected midway-point event determination process of S2002 in FIG. 20.

In S2101, the event information management apparatus 400 determines whether (Ca—Cd)/Ca is equal to or larger than P, where P is a predetermined value that represents reliability and may be given an arbitrary value.

In S2102, when (Ca—Cd)/Ca is equal to or larger than P (“Yes” in S2101), the event information management apparatus 400 updates Ca with Ca—Cd.

In S2103, the event information management apparatus 400 determines whether 1-Cc/Ca is equal to 1.

In S2104, when 1-Cc/Ca is equal to 1 (“Yes” in S2103), the event information management apparatus 400 determines that the uppermost node is the starting point of failures.

In S2105, when (Ca—Cd)/Ca is smaller than P (“No” in S2101) or when 1-Cc/Ca is not equal to 1 (“No” in S2103), the event information management apparatus 400 determines that determination of a starting point of failures is failed.

In S2106, the event information management apparatus 400 resets the counter, and advances the procedure to S1808.

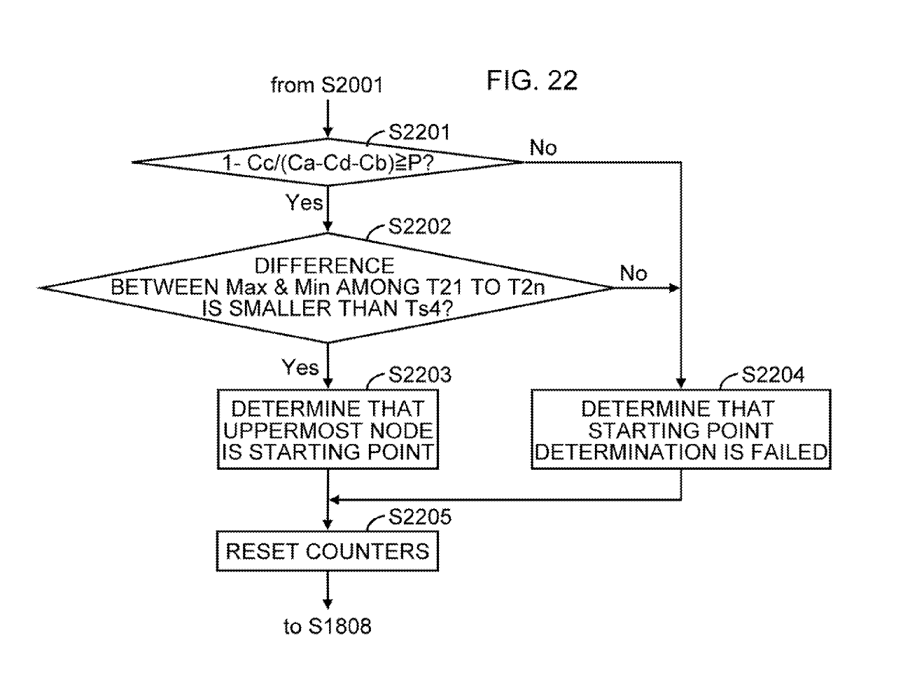

FIG. 22 illustrates an exemplary detailed operation flow of the undetected starting-point event determination process of S2003 in FIG. 20.

In S2201, the event information management apparatus 400 determines whether 1-Cc/(Ca—Cd-Cb) is equal to or larger than P, where P is a predetermined value that represents reliability and may be given an arbitrary value.

In S2202, when 1-Cc/(Ca—Cd-Cb) is equal to or larger than P (“Yes” in S2201), the event information management apparatus 400 determines whether the difference between the maximum value and the minimum value among event occurrence times T21, T22, . . . , T2n (where n is a natural number) is smaller than Ts4.

In S2203, when the difference between the maximum value and the minimum value among event occurrence times T21, T22, . . . , T2n is smaller than Ts4 (“Yes” in S2202), the event information management apparatus 400 determines that the uppermost node is the starting point of failures.

In S2204, when 1-Cc/(Ca—Cd-Cb) is smaller than P (“No” in S2201) or when the difference between the maximum value and the minimum value among event occurrence times T21, T22, . . . , T2n is equal to or larger than Ts4 (“No” in S2202), the event information management apparatus 400 determines that determination of a starting point of failures is failed.

In S2205, the event information management apparatus 400 resets the counters, and advances the procedure to S1808.

In other words, in S2202, when all the events (that have occurred at T21 to T2n) have occurred within a time period less than Ts4, it is determined that the uppermost node is the starting point of failures.

There is a modified embodiment of the above discussed undetected starting-point event determination process. In this modified embodiment, it is assumed that T2i (i=1, . . . , n) represents each event occurrence time and that Tmin represents the minimum value of T2i. When the ratio of the number of combinations of nodes that satisfy a condition |T2i−Tmin|<Ts4 is larger than a predetermined ratio R, it may be determined that the uppermost node is the starting point of failures.

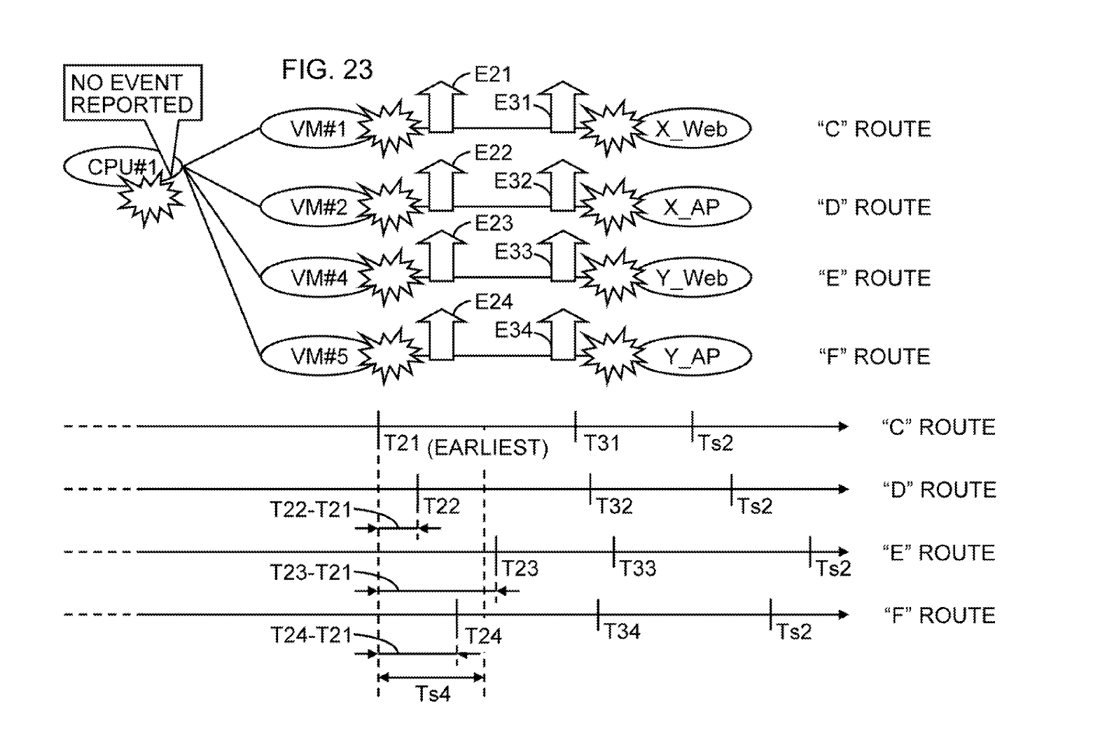

FIG. 23 illustrates a concrete example of estimation of an event dependency relating to an undetected starting-point event. In the example illustrated in FIG. 23, the CPU#1 is connected to the VM#1, the VM#2, the VM#4, and the VM#5, and events are reported from the VM#1, the VM#2, the VM#4, and the VM#5. The VM#1 is connected to the X_Web, the VM#2 is connected to the X_AP, the VM#4 is connected to the Y_Web, and the VM#5 is connected to the Y_AP. Events are also reported from the X_Web, the X_AP, the Y_Web, and the Y_AP.

A route from the CPU#1 to the X_Web via the VM#1 is “C” route. The VM#1 reports an event E21 at the time T21, and the X_Web reports an event E31 at the time T31.

A route from the CPU#1 to the X_AP via the VM#2 is “D” route. The VM#2 reports an event E22 at the time T22, and the X_AP reports an event E32 at the time T32.

A route from the CPU#1 to the Y_Web via the VM#4 is “E” route. The VM#4 reports an event E23 at the time T23, and the Y_Web reports an event E33 at the time T33.

A route from the CPU#1 to the Y_AP via the VM#5 is “F” route. The VM#5 reports an event E24 at the time T24, and the Y_AP reports an event E34 at the time T34.

Supposing that the minimum value of the occurrence times T21 to T24 of the events E21 to E24, that is, the time at which the earliest event is reported, is T21, the event information management apparatus 400 determines whether the occurrence time of each event minus T21 is smaller than Ts4. In other words, in the example illustrated in FIG. 23, whether each of T21−T21, T22−T21, T23−T21, and T24−T21 is smaller than Ts4 is determined.

For example, supposing that T21−T21, T22−T21, and T24−T21 are smaller than Ts4, T23−T21 is equal to or larger than Ts4, and R is equal to 0.7, three routes (that is, “C”, “D”, and “F” routes) of the four routes (that is, “C” to “F” routes) satisfy the condition of being smaller than Ts4, with the result that the ratio=3/4=0.75>R, and it may be determined that the CPU#1 is a starting point of failures.

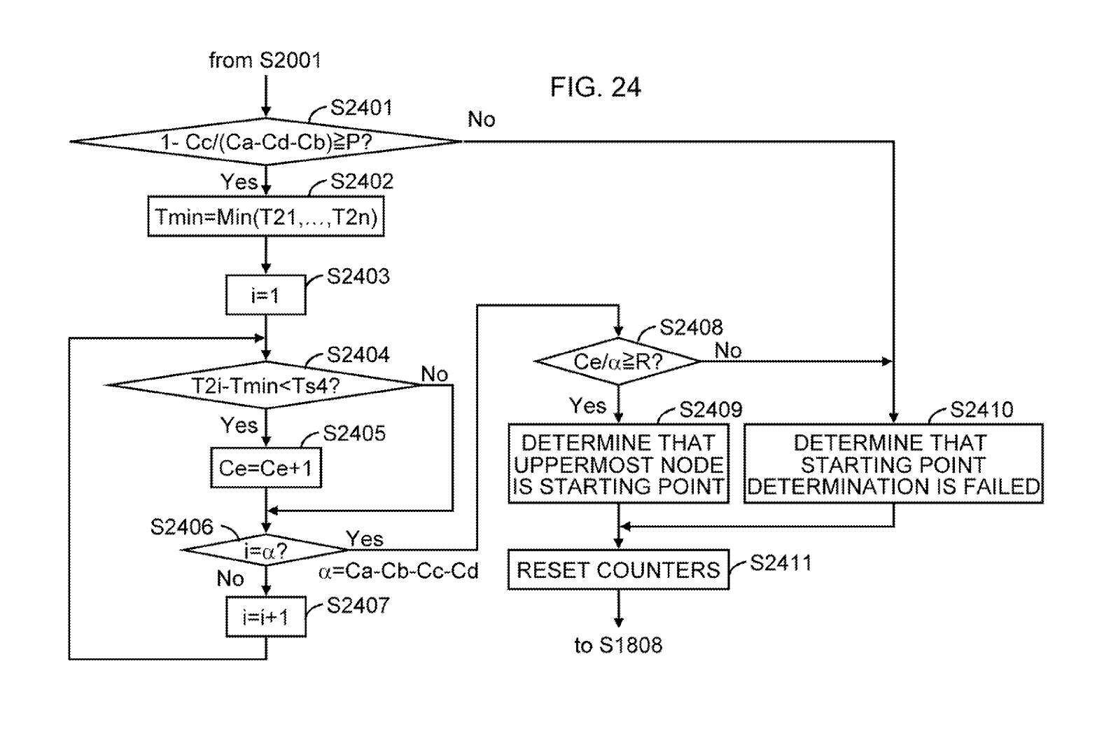

FIG. 24 illustrates an exemplary modified operation flow of the undetected starting-point event determination process of S2003 in FIG. 2.

In S2401, the event information management apparatus 400 determines whether 1-Cc/(Ca—Cd-Cb) is equal to or larger than P, where P is a predetermined value that represents reliability and may be given an arbitrary value.

In S2402, when 1-Cc/(Ca—Cd-Cb) is equal to or larger than P (“Yes” in S2401), the event information management apparatus 400 sets Tmin to the minimum value of event occurrence times T21 to T2n (n is a natural number).

In S2403, the event information management apparatus 400 initializes a variable i to 1.

In S2404, the event information management apparatus 400 determines whether a condition T2i−Tmin<Ts4 is satisfied.

In S2405, when the condition T2i−Tmin<Ts4 is satisfied (“Yes” in S2404), the event information management apparatus 400 increments a counter Ce (the initial value thereof is Ce=0). Here, T2i is an occurrence time of the first event that has occurred among a combination of nodes that satisfies the condition of S2401.

In S2406, after S2405, or when the condition T2i−Tmin<Ts4 is not satisfied (“No” in S2404), the event information management apparatus 400 determines whether i=α, where α=Ca—Cb-Cc-Cd.

In S2407, when i≠α (“No” in S2406), the event information management apparatus 400 increments i, and returns the process to S2404.

In S2408, when i=α (“Yes” in S2406), the event information management apparatus 400 determines whether Ce/α is equal to or larger than a predetermined ratio R.

In S2409, when Ce/α is equal to or larger than the predetermined ratio R (“Yes” in S2408), the event information management apparatus 400 determines that the uppermost node is the starting point of failures.

In S2410, when 1-Cc/(Ca—Cd-Cb) is smaller than P (“No” in S2401) or when Ce/α is smaller than the predetermined ratio R (“No” in S2408), the event information management apparatus 400 determines that determination of a starting point of failures is failed.

In S2411, the event information management apparatus 400 resets the counters, and returns the process to S1808.

As discussed above, according to the embodiments, the event information management apparatus 400 may determine that a third event has occurred in dependence upon a first event by taking the difference between the occurrence time of the first event and the occurrence time of the third event into consideration. The event information management apparatus 400 may also determine that plural second events have occurred in dependence upon a first event by taking the differences between the occurrence times of the plural second events into consideration. Therefore, the event information management apparatus 400 may determine the dependency between events even if there is an undetected event.

Because the event information management apparatus 400 may preserve event information regarding starting points of failures, important event information may be selectively preserved.

If the event information regarding a starting point of failures is preserved, with reference to dependency information by using the event information as a clue, event information regarding an event occurred at a managed object reachable by following the dependency may be retrieved from the DBs 124 to 126. Therefore, the amount of preserved data may be decreased, and the efficiency of event retrieval may be achieved. If an event that is a starting point of failures is identified, a managed object at which the event has occurred may be easily identified, with the result that the maintenance may be easily performed.

By preserving the degree of reliability along with the event information to be preserved, an administrator may use the degree of reliability as an index for determination regarding whether to search the DBs 124 to 126.

According to the embodiments, any objects that report failure events or monitoring events may be managed. For example, the embodiments may be applied to cloud computing, in which a network configuration, a server, a client, and a logical layer disposed therebetween are treated as managed objects.

The embodiments may be advantageous to such a system, that monitors servers, clients, and networks connecting the servers and the clients with each other used in the cloud computing system environment, and that is equipped with a storage for storing a vast amount of event information as logs.

The event dependency management methods discussed in the embodiments may be realized by executing a program prepared in advance in a computer such as a personal computer or a workstation. The event dependency management program may be recorded in a computer readable medium such as a hard disk, a flexible disk, a compact disk read-only memory (CD-ROM), a magneto-optic disk (MO), or a digital versatile disk (DVD), and read out and executed by a computer. Alternatively, the event dependency management program may be delivered via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been discussed in detail, it should be understood that the various changes, substitutions, and alterations could be made hereto without departing from the spirit and scope of the invention.

What is claimed is:

1. An event dependency management apparatus for managing a first managed object at which a first event may occur, a second managed object at which a second event may occur in dependence upon the first event, and a third managed object at which a third event may occur in dependence upon the second event, the event dependency management apparatus comprising:
a processor to
calculate a difference between an occurrence time of the first event and an occurrence time of the third event, and
determine that the third event has occurred in dependence upon the first event when the calculated difference is smaller than a predetermined time.

2. An event dependency management apparatus for managing a first managed object at which a first event may occur and a plurality of second managed objects at each of which a second event may occur in dependence upon the first event, the event dependency management apparatus comprising:
a processor to
calculate differences between occurrence times of two second events among second events occurred at the plurality of second managed objects, and
determine that the second events have occurred in dependence upon the first event when the calculated differences are smaller than a predetermined time.

3. The event dependency management apparatus according to claim 2, wherein
the processor further
calculates a degree of reliability on the basis of an first number of the plurality of second managed objects and a second number of the second managed objects at which the second events have occurred, and
determines that the second events have occurred in dependence upon the first event when the calculated degree of reliability is larger than a predetermined value and the calculated differences are smaller than the predetermined time.

4. The event dependency management apparatus according to claim 2, wherein
the processor further
generates a dummy value of an occurrence time of the first event when the processor has determined that the second events have occurred in dependence upon the first event.

5. A computer-readable, non-transitory medium storing a program that causes a computer to execute an event dependency management method, the computer managing a first managed object at which a first event may occur, a second managed object at which a second event may occur in dependence upon the first event, and a third managed object at which a third event may occur in dependence upon the second event, the event dependency management method comprising:
calculating a difference between an occurrence time of the first event and an occurrence time of the third event, and
determining that the third event has occurred in dependence upon the first event when the calculated difference is smaller than a predetermined time.

6. A computer-readable, non-transitory medium storing a program that causes a computer to execute an event dependency management method, the computer managing a first managed object at which a first event may occur and a plurality of second managed objects at each of which a second event may occur in dependence upon the first event, the event dependency management method comprising:
calculating differences between occurrence times of two second events among second events occurred at the plurality of second managed objects, and
determining that the second events have occurred in dependence upon the first event when the calculated differences are smaller than a predetermined time.

7. An event dependency management method executed by an event dependency management apparatus for managing a first managed object at which a first event may occur, a second managed object at which a second event may occur in dependence upon the first event, and a third managed object at which a third event may occur in dependence upon the second event, the event dependency management method comprising:
calculating a difference between an occurrence time of the first event and an occurrence time of the third event, and
determining, by the event dependency management apparatus, that the third event has occurred in dependence upon the first event when the calculated difference is smaller than a predetermined time.

8. An event dependency management method executed by an event dependency management apparatus for managing a first managed object at which a first event may occur and a plurality of second managed objects at each of which a second event may occur in dependence upon the first event, the event dependency management method comprising:
calculating differences between occurrence times of two second events among second events occurred at the plurality of second managed objects, and
determining, by the event dependency management apparatus, that the second events have occurred in dependence upon the first event when the calculated differences are smaller than a predetermined time.
